(19) United States
(12) Patent Application Publication
(10) Pub. No.: US 2007/0018461 A1
(43) Pub. Date: Jan. 25, 2007

(54) Fluid driven electricity generator

(76) Inventor: James D. Hardy, Milford, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/489,097

(22) Filed: Jul. 19, 2006

Related U.S. Application Data
(60) Provisional application No. 60/701,647, filed on Jul. 21, 2005.

(51) Int. Cl. F03B 13/00

(52) U.S. Cl. 290/54

(57) ABSTRACT

This invention is a device for generating electricity. A liquid pump pumps liquid through a tube to a nozzle. The nozzle directs a stream of liquid at a waterwheel. The waterwheel drives a shaft with a large diameter belt wheel. The wheel drives a belt which in turn drives a small diameter belt wheel. The small diameter belt wheel drives a generator which produces electricity for external use and also the electricity to drive the liquid pump.

### CROSS-REFERENCE TO RELATED APPLICATIONS

This application claims priority to U.S. Provisional Patent Application Ser. No. 60/701,647, filed Jul. 21, 2005.

### BACKGROUND OF THE INVENTION

1. Field of the Invention

The present invention relates to portable electrical generators. More particularly, it relates to an electrical generator driven by recirculating fluid.

2. Discussion of Related Art

Electrical generators are generally expensive to obtain, maintain and operate. Generators typically are inefficient. They consume large amounts of power to create low levels of electricity. Often, they include a gasoline motor for turning the generator to produce electricity. The gasoline motor pollutes the environment. The motor is often very noisy. The noise may force the generator to be positioned a long distance from where the electricity will be used. This distance adds to the inefficiency of operation of the generator. Furthermore, while portable, generators are often very heavy. This makes it difficult to be moved, often requiring multiple people to move the generator. Moving them by hand long distances is not practical. Therefore, a need exists for a portable electrical generator which is quiet and efficient, with minimal impact on the environment.

Fluid operated generators have been suggested in several patents and patent applications. In such generators, a fluid is outputted in a manner which rotates an axle. The axle is used to turn the electrical generator. With such systems, pressure from a water system is used to move the fluid for the generator. Thus, a pressurized source of water is needed to operate the generator. Furthermore, the water must be disposed of once it has passed through the generator. Such generators are inefficient. Also, these generators are not portable.

### SUMMARY OF THE INVENTION

The present invention provides a method and apparatus for generating electricity which uses recirculating fluid, such as water. According to one aspect of the invention, a pump is used to move fluid from a basin through a tube to a nozzle. The nozzle is positioned to direct a stream of fluid at a waterwheel. The waterwheel is coupled to a generator for generating electricity. The fluid returns to the basin after it has provided energy to the waterwheel.

According to another aspect of the invention, the waterwheel is connected to a first shaft. The first shaft is coupled to a second shaft which drives the generator. According to another aspect of the invention, the first and second shafts are coupled with a belt. According to another aspect of the invention, a large diameter belt wheel is attached to the first shaft and a small diameter belt is attached to the second shaft.

According to another aspect of the invention, a starting system provides power to the pump. The starting system includes a battery. Alternatively, the starting system could include an electrical motor or a manual crank. According to another aspect of the invention, once the generator commences generation of power, the power is used to continue operation of the pump.

### BRIEF DESCRIPTION OF THE DRAWINGS

FIG. 1 is a cross sectional side view of an electrical generator according to an embodiment of the present invention.

FIG. 2 illustrates an array of electrical generators according to a second embodiment of the present invention.

### DETAILED DESCRIPTION

An electrical generator system 100 according to an embodiment of the present invention includes a housing 20 having three compartments 21, 22, 23. A first compartment 21 forms a basin to hold a liquid 15. According to an embodiment of the present invention, water is used as the liquid. Of course, other liquids could be used. Sufficient liquid 15 must be in the first compartment 21 to allow operation of the electrical generator system 100. A drain 16 is included in the first compartment 21 for removing liquid 15 as necessary.

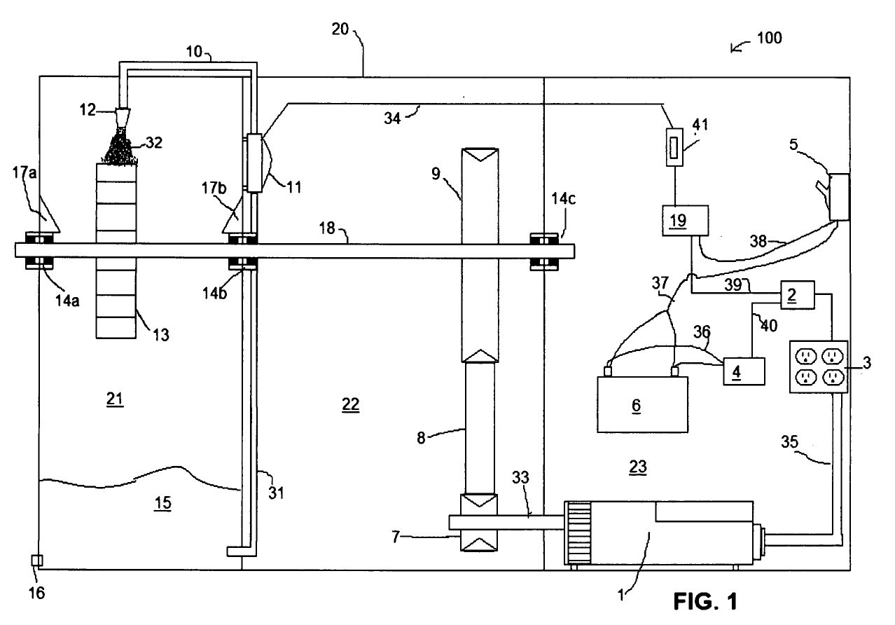

A tube 31 extends from the first compartment 21 to the second compartment 22 at a position below the level of the liquid 15. The second compartment 22 is sealed from the first compartment 21 so that the liquid remains in the first compartment 21. The tube 31 extends in the second compartment 22 to a pump 11. Any type of pump can be used which will move the liquid 15. The pump 11 sucks liquid 15 from the first compartment 21 through tube 31 and forces it into a second tube 10. A nozzle 12 is positioned at the end of the second tube 10. The nozzle 12 directs a stream of liquid 32 at a waterwheel 13. The nozzle 12 may be of any known type. The stream of liquid 32 is illustrated in FIG. 1 as a spread stream. It could also be a narrow stream. The stream of liquid 32 should be such that it efficiently rotates the waterwheel 13. The waterwheel 13 may be of any known type which operates to rotate when the stream of water is directed at it. The waterwheel 13 may include fins, paddles, or other structures extending from the waterwheel to capture the energy from the stream of liquid.

The waterwheel 13 is mounted on and drives a shaft 18. The shaft extends through the first compartment 21 and into the second compartment 22 of the housing 20. The shaft 18 is mounted on bearings 14a, 14b, 14c positioned in the walls of the compartments 21, 22, 23. According to an embodiment of the invention, the bearings 14a, 14b, 14c are free spinning ball bearings. Of course, other types of bearings could be used. Splash guards 17a, 17b are positioned in the first compartment 21 around the bearings 14a, 14b to minimize the impact of liquid 15 from the stream 32 or from the waterwheel 13 on the bearings 14a, 14b. A large diameter belt wheel 9 is connected to the shaft 18 in the second compartment 22. The wheel 9 drives a belt 8 which in turn drives a small diameter belt wheel 7 on a second shaft 33.

The second shaft 33 extends into the third compartment 23, which includes an electrical generator 1. The generator 1 produces electricity as the shaft 33 is turned. Preferably, the generator 1 produces 120 volt AC current. The produced electricity is provided to standard receptacles 3 located in the third compartment 23 through wire 35. The receptacles 3 provide power for any external use. Electricity from the generator 1 is also provided to an AC/DC transformer 2. The transformer 2 may be connected to the receptacles, as shown, or connected directly to the output of the generator 1. The transformer 2 has two DC outputs 39, 40. One output is supplied to a DC transfer switch 19. The DC transfer switch 19 is connected by electrical wire 34, through switch 41 to the pump 11. When the generator 1 is providing electricity, the pump 11 operates on electricity from the generator 1 through the DC transformer 2 and the DC transfer switch 19. Of course, depending upon the type of pump used, AC power could be provided directly to the pump 11 from the generator 1. Switch 41 is used to turn off the generator system 100. When switch 41 is turned off, electricity is terminated to the pump 11, which stops pumping. When the pump 11 stops pumping, the liquid stream 32 is no longer provided to the waterwheel 13. The system will slow down and stop generating electricity.

The generator system can start operation in various manners. For example, a crank or pull cord can be used to commence rotation of the shaft 18. An external source, such as an electric motor could also be used to commence rotation of shaft 18. An external electrical source could be provided to the pump 11 to start operation of the generator system 100.

According to an embodiment of the invention, as illustrated in FIG. 1, the pump 11 is used to start operation of the generator system 100. A battery 6, such as a standard 12V battery, is connected to the DC transfer switch 19 through switch 5. When switch 5 is turned on, the transfer switch 19 provides power from the battery 6 to the pump 11. Once the generator 1 begins providing electricity, the DC transfer switch 19 disconnects from the battery 6 and provides power from the generator 1 to the pump 11 for continued operation. A battery charger 4 is connected to the DC transformer 2. After the battery has been used to start the generator system 6 it is recharged with power from the generator 1.

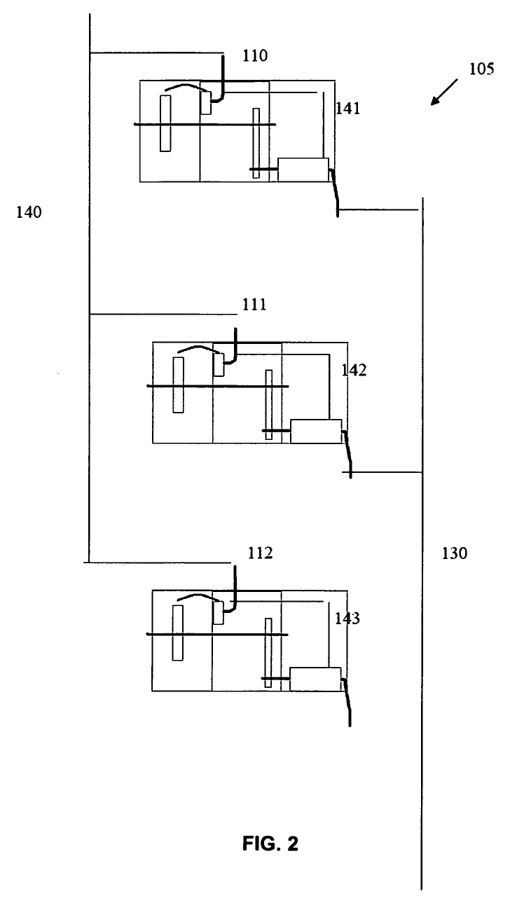

FIG. 2 illustrates an array of generator systems which can be utilized to create additional electrical power. A plurality of generator systems 110, 111, 112 are connected in an array 105. Each of the generator systems 110, 111, 112 are of a form as described above with respect to FIG. 1. Each includes a pump, waterwheel and generator. The outputs from multiple generators are combined to provide a single output 130. An electrical input 140 is connected to the pumps to start each of the generators. The input could be from an outside source, such as house current. Each generator system 110, 111, 112 includes a feedback loop 141, 142, 143 from the respective generator to the pump. Once the generator systems 110, 111, 112 have commenced operation, they can be self sustaining in that the generated electricity is used to continue operation of the pump.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A generator system comprising:
a liquid repository;
a liquid pump coupled to the liquid repository and providing a stream of liquid which returns to the liquid repository;
a waterwheel positioned within the stream of liquid to provide rotation of the waterwheel; and
an electrical generator operated by rotation of the waterwheel to generate electricity.

2. The generator system according to claim 1, further comprising:
a first shaft connected to the waterwheel so that it rotates with the waterwheel;
a second shaft coupled to the first shaft for joint rotation; and
wherein the second shaft is connected to the electrical generator.

3. The generator system according to claim 2, further comprising:
a first belt wheel connected to the first shaft;
a second belt wheel connected to the second shaft; and
a belt coupling the first belt wheel and the second belt wheel.

4. The generator system according to claim 1, further comprising:
a transfer switch coupled to the electrical generator to provide power from the electrical generator to the liquid pump when the electrical generator is generating electricity.

5. The generator system according to claim 4, further comprising:
a battery connected to the transfer switch; and
wherein the transfer switch provides power from the battery to the liquid pump when the electrical generator is not generating electricity.

6. The generator system according to claim 5, further comprising a battery charger coupled to the electrical generator and the battery to recharge the battery when the electrical generator is generating electricity.

7. A generator array system comprising:
a plurality of generator systems, each generator system including:
a liquid repository;
a liquid pump coupled to the liquid repository and providing a stream of liquid which returns to the liquid repository;
a waterwheel positioned within the stream of liquid to provide rotation of the waterwheel;
an electrical generator operated by rotation of the waterwheel to generate electricity; and
a generator output providing electricity generated by the electrical generator; and
an output connected to the generator output of each of the plurality of generator systems to provide an electrical output from the generator array system.

8. The generator array system according to claim 7 further comprising:
an input providing electrical power to the liquid pump of each of the plurality of generator systems.

9. The generator array system according to claim 8, wherein each of the generator systems includes:
a transfer switch coupled to the input, a respective electrical generator and a respective liquid pump for providing power to the respective liquid pump from one of the input and the respective electrical generator.
